(19) United States
(12) Patent Application Publication
(10) Pub. No.: US 2022/0012526 A1
(43) Pub. Date: Jan. 13, 2022

(54) SYSTEMS AND METHODS FOR IMAGE RETRIEVAL

(71) Applicant: ZHEJIANG DAHUA TECHNOLOGY CO., LTD., Hangzhou (CN)

(72) Inventors: Huadong PAN, Hangzhou (CN); He SUN, Hangzhou (CN); Shixian LUO, Hangzhou (CN)

(73) Assignee: ZHEJIANG DAHUA TECHNOLOGY CO., LTD., Hangzhou (CN)

(21) Appl. No.: 17/447,293

(22) Filed: Sep. 10, 2021

Related U.S. Application Data
(63) Continuation of application No. PCT/CN2019/127376, filed on Dec. 23, 2019.

(30) Foreign Application Priority Data
Mar. 12, 2019 (CN) 201910185837.0

(51) Int. Cl. G06K 9/62; G06K 9/46; G06F 16/53; G06N 3/08

(52) U.S. Cl. CPC G06K 9/6215; G06N 3/08; G06F 16/53; G06K 9/46

(57) ABSTRACT

The present disclosure relates to systems and methods for image retrieval. The system may determine a plurality of difference degrees associated with an image set including a plurality of candidate images and a target image, each of the plurality of difference degrees corresponding to two images in the image set. For each image in the image set, the system may determine an extended subset based on the plurality of difference degrees. For each of the plurality of candidate images, the system may determine an extended difference degree between the candidate image and the target image based on an extended subset corresponding to the candidate image and an extended subset corresponding to the target image. The system may identify a result image corresponding to the target image from the plurality of candidate images based on the extended difference degrees corresponding to the plurality of candidate images.

### CROSS-REFERENCE TO RELATED APPLICATIONS

This application is a Continuation of International Application No. PCT/CN2019/127376, filed on Dec. 23, 2019, which claims priority to Chinese Patent Application No. 201910185837.0 filed on Mar. 12, 2019, the contents of which are incorporated herein by reference in their entirety.

### TECHNICAL FIELD

The present disclosure generally relates to image processing field, and in particular, to systems and methods for image retrieval.

### BACKGROUND

With the development of video surveillance technology in various fields (e.g., environment monitoring, security monitoring), the exploration of image retrieval has developed rapidly nowadays. Commonly, an image retrieval system can identify a result image corresponding to a target image from a plurality of candidate images to be retrieved by analyzing a difference degree between the target image and each of plurality of candidate images. However, in some situations, information loss may occur in analyzing the difference degree, which may reduce the efficiency and accuracy of the image retrieval. Therefore, it is desirable to provide systems and methods for executing image retrieval efficiently and accurately.

### SUMMARY

An aspect of the present disclosure relates to an image retrieval method for retrieving a relevant image corresponding to a target image from a plurality of candidate images to be retrieved. The method may include specifying an image set including the plurality of candidate images to be retrieved and the target image. For each image in the image set, the method may include determining a plurality of image difference degrees between the image and remainder images in the image set; determining an extended neighbor image set corresponding to the image based on image difference degrees among the images in the image set; and ranking images in the extended neighbor image set. For each of the plurality of candidate images, the method may include determining an image set difference degree between an extended neighbor image set corresponding to the target image and an extended neighbor image set corresponding to the candidate image and designating the image set difference degree as an extended difference degree between the target image and the candidate image. The method may further include determining the relevant image corresponding to the target image based on a plurality of extended difference degrees corresponding to the plurality of candidate images.

In some embodiments, for each image in the image set, the determining a plurality of image difference degrees between the image and remainder images in the image set may include, for each image in the image set, obtaining a feature vector corresponding to the image by using a trained convolutional neural network and determining the plurality of image difference degrees between the image and the remainder images in the image set based on feature vectors corresponding to the image and the remainder images in the image set.

In some embodiments, for each image in the image set, the obtaining a feature vector corresponding to the image by using a trained convolutional neural network may include, for each image in the image set, obtaining a hash feature vector corresponding to the image by using a hash coding layer in the trained convolutional neural network.

In some embodiments, for each image in the image set, the determining an extended neighbor image set corresponding to the image based on image difference degrees among the images in the image set may include, for each image in the image set, selecting, from the remainder images in the image set, top N₁ images based on the plurality of difference degrees between the image and the remainder images as a first neighbor image set corresponding to the image and determining the extended neighbor image set corresponding to the image based on the first neighbor image set corresponding to the image.

In some embodiments, for each image in the image set, the determining an extended neighbor image set corresponding to the image based on image difference degrees among the images in the image set may further include, for each image in the image set, selecting, from the remainder images in the image set, top N₂ images based on the plurality of image difference degrees between the image and the remainder images as a second neighbor image set corresponding to the image; for each image in the first neighbor image set corresponding to the image, obtaining a second neighbor image set corresponding to the image; and determining the extended neighbor image set corresponding to the image by combining the first neighbor image set and a plurality of second neighbor image sets corresponding to the images in the first neighbor image set.

In some embodiments, the determining an image set difference degree between an extended neighbor image set corresponding to the target image and an extended neighbor image set corresponding to the candidate images may include determining a target image difference degree between the target image and the extended neighbor image set corresponding to the candidate image; determining a candidate image difference degree between the candidate image and the extended neighbor image set corresponding to the target image; and determining a mean value of the target image difference degree and the candidate image difference degree as the image set difference degree.

In some embodiments, the determining a target image difference degree between the target image and the extended neighbor image set corresponding to the candidate image may include, for each image in the extended neighbor image set corresponding to the candidate image, determining a weighting coefficient corresponding to the image based on a ranking position of the image; determining the target image difference degree by weighting a plurality of image difference degrees between the target image and the images in the extended neighbor image set corresponding to the candidate image; and the determining a candidate image difference degree between the candidate image and the extended neighbor image set corresponding to the target image may include, for each image in the extended neighbor image set corresponding to the target image, determining a weighting coefficient corresponding to the image based on a ranking position of the image and determining the candidate image difference degree by weighting a plurality of image difference degrees between the candidate image and the images in the extended neighbor image set corresponding to the target image.

In some embodiments, the image retrieval method may further include determining a retrieval accuracy based on a category of the target image and a category of the result image and iteratively performing an image retrieval process until the retrieval accuracy no longer increases.

Another aspect of the present disclosure relates to an image retrieval device including a processor and a storage. The storage may store a computer program and the processor may be configured to execute the computer program to implement operations of the image retrieval method for retrieving a relevant image corresponding to a target image from a plurality of candidate images to be retrieved.

A further aspect of the present disclosure relates to a computer storage medium storing a computer program. When the computer program is executed by a processor, operations of the image retrieval method for retrieving a relevant image corresponding to a target image from a plurality of candidate images to be retrieved may be implemented.

A still further aspect of the present disclosure relates to a system for image retrieval. The system may include at least one storage medium including a set of instructions and at least one processor in communication with the at least one storage medium. When executing the set of instructions, the at least one processor may be directed to cause the system to determine a plurality of difference degrees associated with an image set including a plurality of candidate images and a target image, each of the plurality of difference degrees corresponding to two images in the image set; determine, for each image in the image set, an extended subset based on the plurality of difference degrees; determine, for each of the plurality of candidate images, an extended difference degree between the candidate image and the target image based on an extended subset corresponding to the candidate image and an extended subset corresponding to the target image; and identify a result image corresponding to the target image from the plurality of candidate images based on the extended difference degrees corresponding to the plurality of candidate images.

In some embodiments, to determine the plurality of difference degrees associated with the image set including the plurality of candidate images and the target image, the at least one processor may be directed to cause the system further to determine, for each image in the image set, a feature vector corresponding to the image by using a trained neural network model and determine a difference degree between any two images in the image set based on feature vectors corresponding to the two images.

In some embodiments, the neural network model may include a hash coding layer and a binary coding layer. The feature vector may be a binary hash coding feature vector.

In some embodiments, to determine the difference degree between any two images in the image set based on the feature vectors corresponding to the two images, the at least one processor may be directed to cause the system further to determine the difference degree between any two images in the image set by determining at least one of a Hamming distance, a Euclidean distance, or a cosine distance based on the feature vectors corresponding to the two images.

In some embodiments, to determine, for each image in the image set, the extended subset based on the plurality of difference degrees, the at least one processor may be directed to cause the system further to rank, for each image in the image set, remainder images in the image set based on difference degrees between the remainder images and the image; determine a first neighbor subset including top N₁ images based on the ranking result; for each image in the first neighbor subset, rank remainder images in the image set based on difference degrees between the remainder images and the image and determine a second neighbor subset including top N₂ images based on the ranking result; and determine the extended subset for the image in the image set by combining the first neighbor subset and a plurality of second neighbor subsets corresponding to the images in the first neighbor subset.

In some embodiments, to determine, for each of the plurality of candidate images, the extended difference degree between the candidate image and the target image based on the extended subset corresponding to the candidate image and the extended subset corresponding to the target image, the at least one processor may be directed to cause the system further to determine a first global feature vector of the extended subset corresponding to the target image; determine a second global feature vector of the extended subset corresponding to the candidate image; and determine the extended difference degree between the candidate image and the target image based on the first global feature vector and the second global feature vector.

In some embodiments, to determine, for each of the plurality of candidate images, the extended difference degree between the candidate image and the target image based on the extended subset corresponding to the candidate image and the extended subset corresponding to the target image, the at least one processor may be directed to cause the system further to determine a first global difference degree between the target image and the extended subset corresponding to the candidate image; determine a second global difference degree between the candidate image and the extended subset corresponding to the target image; and determine the extended difference degree between the candidate image and the target image based on the first global difference degree and the second global difference degree.

In some embodiments, to determine the first global difference degree between the target image and the extended subset corresponding to the candidate image, the at least one processor may be directed to cause the system further to determine the first global difference degree between the target image and the extended subset corresponding to the candidate image by weighting a plurality of difference degrees between the target image and images in the extended subset corresponding to the candidate image, wherein for each of the images in the extended subset corresponding to the candidate image, a weighting coefficient corresponding to the image is negatively correlated with a difference degree between the image and the target image. To determine the second global difference degree between the candidate image and the extended subset corresponding to the target image, the at least one processor may be directed to cause the system further to determine the second global difference degree between the candidate image and the extended subset corresponding to the target image by weighting a plurality of difference degrees between the candidate image and images in the extended subset corresponding to the target image, wherein for each of the images in the extended subset corresponding to the target image, a weighting coefficient corresponding to the image is negatively correlated with a difference degree between the image and the candidate image.

In some embodiments, the at least one processor may be directed to cause the system further to identify a first category of the target image and a second category of the result image; determine a retrieval accuracy based on the first category and the second category; and iteratively perform an image retrieval process until the retrieval accuracy satisfies a preset condition.

A still further aspect of the present disclosure relates to a method implemented on a computing device including at least one processor, at least one storage medium, and a communication platform connected to a network. The method may include determining a plurality of difference degrees associated with an image set including a plurality of candidate images and a target image, each of the plurality of difference degrees corresponding to two images in the image set; determining, for each image in the image set, an extended subset based on the plurality of difference degrees; determining, for each of the plurality of candidate images, an extended difference degree between the candidate image and the target image based on an extended subset corresponding to the candidate image and an extended subset corresponding to the target image; and identifying a result image corresponding to the target image from the plurality of candidate images based on the extended difference degrees corresponding to the plurality of candidate images.

In some embodiments, the determining the plurality of difference degrees associated with the image set including the plurality of candidate images and the target image may include determining, for each image in the image set, a feature vector corresponding to the image by using a trained neural network model and determining a difference degree between any two images in the image set based on feature vectors corresponding to the two images.

In some embodiments, the neural network model may include a hash coding layer and a binary coding layer. The feature vector may be a binary hash coding feature vector.

In some embodiments, the determining the difference degree between any two images in the image set based on the feature vectors corresponding to the two images may include determining the difference degree between any two images in the image set by determining at least one of a Hamming distance, a Euclidean distance, or a cosine distance based on the feature vectors corresponding to the two images.

In some embodiments, the determining, for each image in the image set, the extended subset based on the plurality of difference degrees may include ranking, for each image in the image set, remainder images in the image set based on difference degrees between the remainder images and the image; determining a first neighbor subset including top N₁ images based on the ranking result; ranking, for each image in the first neighbor subset, remainder images in the image set based on difference degrees between the remainder images and the image and determining a second neighbor subset including top N₂ images based on the ranking result; and determining the extended subset for the image in the image set by combining the first neighbor subset and a plurality of second neighbor subsets corresponding to the images in the first neighbor sub-set.

In some embodiments, the determining, for each of the plurality of candidate images, the extended difference degree between the candidate image and the target image based on the extended subset corresponding to the candidate image and the extended subset corresponding to the target image may include determining a first global feature vector of the extended subset corresponding to the target image; determining a second global feature vector of the extended subset corresponding to the candidate image; and determining the extended difference degree between the candidate image and the target image based on the first global feature vector and the second global feature vector.

In some embodiments, the determining, for each of the plurality of candidate images, the extended difference degree between the candidate image and the target image based on the extended subset corresponding to the candidate image and the extended subset corresponding to the target image may include determining a first global difference degree between the target image and the extended subset corresponding to the candidate image; determining a second global difference degree between the candidate image and the extended subset corresponding to the target image; and determining the extended difference degree between the candidate image and the target image based on the first global difference degree and the second global difference degree.

In some embodiments, the determining the first global difference degree between the target image and the extended subset corresponding to the candidate image may include determining the first global difference degree between the target image and the extended subset corresponding to the candidate image by weighting a plurality of difference degrees between the target image and images in the extended subset corresponding to the candidate image, wherein for each of the images in the extended subset corresponding to the candidate image, a weighting coefficient corresponding to the image is negatively correlated with a difference degree between the image and the target image. The determining the second global difference degree between the candidate image and the extended subset corresponding to the target image may include determining the second global difference degree between the candidate image and the extended subset corresponding to the target image by weighting a plurality of difference degrees between the candidate image and images in the extended subset corresponding to the target image, wherein for each of the images in the extended subset corresponding to the target image, a weighting coefficient corresponding to the image is negatively correlated with a difference degree between the image and the candidate image.

In some embodiments, the method may further include identifying a first category of the target image and a second category of the relevant image; determining a retrieval accuracy based on the first category and the second category; and iteratively performing an image retrieval process until the retrieval accuracy satisfies a preset condition.

A still further aspect of the present disclosure relates to a system for image retrieval. The system may include a difference degree determination module, an extended subset determination module, an extended difference degree determination module, and an identification module. The difference degree determination module may be configured to determine a plurality of difference degrees associated with an image set including a plurality of candidate images and a target image, each of the plurality of difference degrees corresponding to two images in the image set. The extended subset determination module may be configured to determine an extended subset for each image in the image set based on the plurality of difference degrees. The extended difference degree determination module may be configured to determine an extended difference degree between each of the plurality of candidate images and the target image based on an extended subset corresponding to the candidate image and an extended subset corresponding to the target image. The identification module may be configured to identify a result image corresponding to the target image from the plurality of candidate images based on the extended difference degrees corresponding to the plurality of candidate images.

In some embodiments, the difference degree determination module may be further configured to determine, for each image in the image set, a feature vector corresponding to the image by using a trained neural network model and determine a difference degree between any two images in the image set based on feature vectors corresponding to the two images.

In some embodiments, the neural network model may include a hash coding layer and a binary coding layer. The feature vector may be a binary hash coding feature vector.

In some embodiments, to determine the difference degree between any two images in the image set based on the feature vectors corresponding to the two images, the difference degree determination module may be further configured to determine the difference degree between any two images in the image set by determining at least one of a Hamming distance, a Euclidean distance, or a cosine distance based on the feature vectors corresponding to the two images.

In some embodiments, the extended subset determination module may be further configured to rank, for each image in the image set, remainder images in the image set based on difference degrees between the remainder images and the image; determine a first neighbor subset including top N₁ images based on the ranking result; for each image in the first neighbor subset, rank remainder images in the image set based on difference degrees between the remainder images and the image and determine a second neighbor subset including top N₂ images based on the ranking result; and determine the extended subset for the image in the image set by combining the first neighbor subset and a plurality of second neighbor subsets corresponding to the images in the first neighbor sub-set.

In some embodiments, the extended difference degree determination module may be further configured to determine a first global feature vector of the extended subset corresponding to the target image; determine a second global feature vector of the extended subset corresponding to the candidate image; and determine the extended difference degree between the candidate image and the target image based on the first global feature vector and the second global feature vector.

In some embodiments, the extended difference degree determination module may be further configured to determine a first global difference degree between the target image and the extended subset corresponding to the candidate image; determine a second global difference degree between the candidate image and the extended subset corresponding to the target image; and determine the extended difference degree between the candidate image and the target image based on the first global difference degree and the second global difference degree.

In some embodiments, to determine the first global difference degree between the target image and the extended subset corresponding to the candidate image, the extended difference degree determination module may be further configured to determine the first global difference degree between the target image and the extended subset corresponding to the candidate image by weighting a plurality of difference degrees between the target image and images in the extended subset corresponding to the candidate image, wherein for each of the images in the extended subset corresponding to the candidate image, a weighting coefficient corresponding to the image is negatively correlated with a difference degree between the image and the target image. To determine the second global difference degree between the candidate image and the extended subset corresponding to the target image, the extended difference degree determination module may be further configured to determine the second global difference degree between the candidate image and the extended subset corresponding to the target image by weighting a plurality of difference degrees between the candidate image and images in the extended subset corresponding to the target image, wherein for each of the images in the extended subset corresponding to the target image, a weighting coefficient corresponding to the image is negatively correlated with a difference degree between the image and the candidate image.

In some embodiments, the identification module may be further configured to identify a first category of the target image and a second category of the relevant image; determine a retrieval accuracy based on the first category and the second category; and iteratively perform an image retrieval process until the retrieval accuracy satisfies a preset condition.

A still further aspect of the present disclosure relates to a non-transitory computer readable medium including executable instructions. When the executable instructions are executed by at least one processor, the executable instructions may direct the at least one processor to perform a method. The method may include determining a plurality of difference degrees associated with an image set including a plurality of candidate images and a target image, each of the plurality of difference degrees corresponding to two images in the image set; determining, for each image in the image set, an extended subset based on the plurality of difference degrees; determining, for each of the plurality of candidate images, an extended difference degree between the candidate image and the target image based on an extended subset corresponding to the candidate image and an extended subset corresponding to the target image; and identifying a result image corresponding to the target image from the plurality of candidate images based on the extended difference degrees corresponding to the plurality of candidate images.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary image retrieval system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary terminal device according to some embodiments of the present disclosure;

FIG. 4 is a flowchart illustrating an exemplary process for image retrieval according to some embodiments of the present disclosure;

FIG. 5 is a flowchart illustrating an exemplary process for image retrieval according to some embodiments of the present disclosure;

FIG. 6 is a block diagram illustrating an exemplary processing device according to some embodiments of the present disclosure;

FIG. 7 is a flowchart illustrating an exemplary process for image retrieval according to some embodiments of the present disclosure;

FIG. 8 is a flowchart illustrating an exemplary process for determining a difference degree between two images according to some embodiments of the present disclosure;

FIG. 9 is a flowchart illustrating an exemplary process for determining an extended subset corresponding to an image according to some embodiments of the present disclosure;

FIG. 10 is a flowchart illustrating an exemplary process for determining an extended difference degree between a target image and a candidate image according to some embodiments of the present disclosure; and

FIG. 11 is a flowchart illustrating an exemplary process for determining an extended difference degree between a target image and a candidate image according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

It will be understood that the terms “system,” “engine,” “unit,” “module,” and/or “block” used herein are one method to distinguish different components, elements, parts, sections, or assemblies of different levels in ascending order. However, the terms may be displaced by other expression if they may achieve the same purpose.

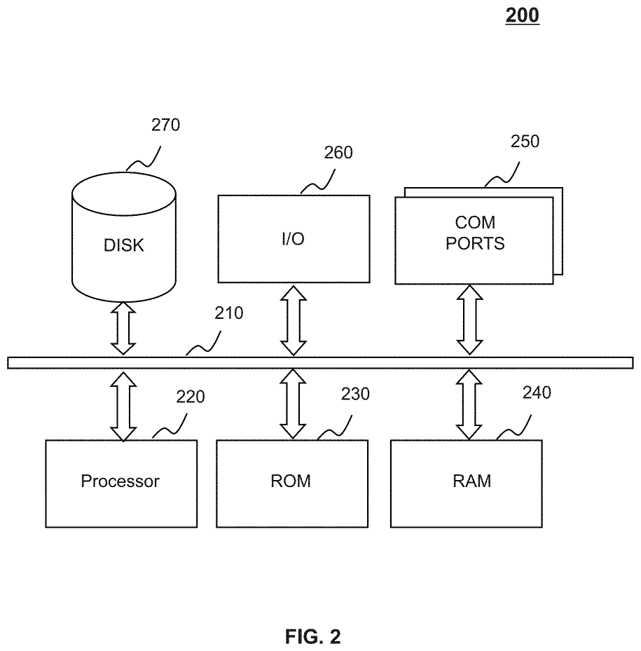

Generally, the words “module,” “unit,” or “block” used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 220 illustrated in FIG. 2) may be provided on a computer readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules (or units or blocks) may be included in connected logic components, such as gates and flip-flops, and/or can be included in programmable units, such as programmable gate arrays or processors. The modules (or units or blocks) or computing device functionality described herein may be implemented as software modules (or units or blocks), but may be represented in hardware or firmware. In general, the modules (or units or blocks) described herein refer to logical modules (or units or blocks) that may be combined with other modules (or units or blocks) or divided into sub-modules (or sub-units or sub-blocks) despite their physical organization or storage.

It will be understood that when a unit, an engine, a module, or a block is referred to as being “on,” “connected to,” or “coupled to” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

In addition, it should be understood that in the description of the present disclosure, the terms “first”, “second”, or the like, are only used for the purpose of differentiation, and cannot be interpreted as indicating or implying relative importance, nor can be understood as indicating or implying the order.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for image retrieval. For a target image, the system may determine a plurality of candidate images to be retrieved associated with the target image and specify an image set including the plurality of candidate images and the target image. Further, the system may determine a plurality of difference degrees associated with the image set, each of the plurality of difference degrees corresponding to two images in the image set. For each image in the image set, the system may determine an extended subset based on the plurality of difference degrees. Also, for each of the plurality of candidate images, the system may determine an extended difference degree between the candidate image and the target image based on the extended subset corresponding to the candidate image and the extended subset corresponding to the target image. Further, the system may identify a result image corresponding to the target image from the plurality of candidate images based on a plurality of extended difference degrees corresponding to the plurality of candidate images.

According to the systems and methods of the present disclosure, when determining the difference degree between any two images, a neural network with a hash coding layer and a binary coding layer is used, which can improve processing speed and reduce storage consumption. Further, for the candidate images to be retrieved, extended subsets are determined and extended difference degrees between the candidate images and the target image are used for identifying the result image, which can improve the efficiency and accuracy of the image retrieval.

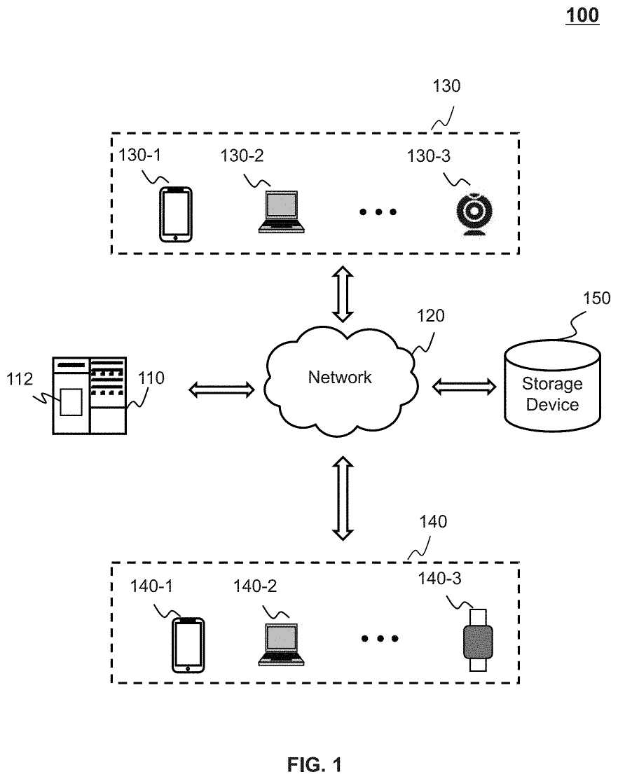

FIG. 1 is a schematic diagram illustrating an exemplary image retrieval system according to some embodiments of the present disclosure. As shown, the image retrieval system 100 may include a server 110, a network 120, an acquisition device 130, a user device 140, and a storage device 150. In some embodiments, the image retrieval system 100 may be applied in various fields, for example, security monitoring, environment monitoring, etc. Take traffic security monitoring as an example, the image retrieval system 100 may determine a plurality of candidate images to be retrieved associated with a target image (e.g., an image including a specific pedestrian) and identify a result image (e.g., an image including the same pedestrian) corresponding to the target image.

The server 110 may be a single server or a server group. The server group may be centralized or distributed (e.g., the server 110 may be a distributed system). In some embodiments, the server 110 may be local or remote. For example, the server 110 may access information and/or data stored in the acquisition device 130, the user device 140, and/or the storage device 150 via the network 120. As another example, the server 110 may be directly connected to the acquisition device 130, the user device 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2 of the present disclosure.

In some embodiments, the server 110 may include a processing device 112. The processing device 112 may process information and/or data relating to image retrieval to perform one or more functions described in the present disclosure. For example, the processing device 112 may determine a plurality of difference degrees associated with an image set including a plurality of candidate images and a target image. Also, for each image in the image set, the processing device 112 may determine an extended subset based on the plurality of difference degrees. Further, for each of the plurality of candidate images, the processing device 112 may determine an extended difference degree based on the extended subset corresponding to the candidate image and the extended subset corresponding to the target image. Finally, the processing device 112 may identify a result image corresponding to the target image from the plurality of candidate images based on a plurality of extended difference degrees. In some embodiments, the processing device 112 may include one or more processing devices (e.g., single-core processing device(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiment, the sever 110 may be unnecessary and all or part of the functions of the server 110 may be implemented by other components (e.g., the acquisition device 130, the user device 140) of the image retrieval system 100. For example, the processing device 112 may be integrated in the acquisition device 130 or the user device 140 and the functions (e.g., identifying a result image) of the processing device 112 may be implemented by the acquisition device 130 or the user device 140.

The network 120 may facilitate exchange of information and/or data for the image retrieval system 100. In some embodiments, one or more components (e.g., the server 110, the acquisition device 130, the user device 140, the storage device 150) of the image retrieval system 100 may transmit information and/or data to other component(s) of the image retrieval system 100 via the network 120. For example, the server 110 may obtain a target image from the acquisition device 130 via the network 120. In some embodiments, the network 120 may be any type of wired or wireless network, or combination thereof. Merely by way of example, the network 120 may include a cable network (e.g., a coaxial cable network), a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof.

The acquisition device 130 may be configured to acquire an image (the “image” herein refers to a single image or a frame of a video). In some embodiments, the acquisition device 130 may include a mobile device 130-1, a computer 130-2, a camera device 130-3, etc. The mobile device 130-1 may include a smart home device, a smart mobile phone, or the like, or any combination thereof. The computer 130-2 may include a laptop, a tablet computer, a desktop, or the like, or any combination thereof. The camera device 130-3 may include a gun camera, a dome camera, an integrated camera, a monocular camera, a binocular camera, a multi-view camera, or the like, or any combination thereof. The image acquired by the acquisition device 130 may be a two-dimensional image, a three-dimensional image, a four-dimensional image, etc. In some embodiments, the acquisition device 130 may include a plurality of components each of which can acquire an image. For example, the acquisition device 130 may include a plurality of sub-cameras that can take pictures or videos simultaneously. In some embodiments, the acquisition device 130 may transmit the acquired image to one or more components (e.g., the server 110, the user device 140, the storage device 150) of the image retrieval system 100 via the network 120.

The user device 140 may be configured to receive information and/or data from the server 110, the acquisition device 130, and/or the storage device 150 via the network 120. For example, the user device 140 may receive information associated with a result image corresponding to the target image from the server 110. In some embodiments, the user device 140 may provide a user interface via which a user may view information and/or input data and/or instructions to the image retrieval system 100. For example, the user may view the result image received from the server 110 via the user interface. As another example, the user may input an instruction associated with a parameter of the image retrieval via the user interface. In some embodiments, the user device 140 may include a mobile phone 140-1, a computer 140-2, a wearable device 140-3, etc. In some embodiments, the user device 140 may include a display that can display information in a human-readable form, such as text, image, audio, video, graph, animation, or the like, or any combination thereof. The display of the user device 140 may include a cathode ray tube (CRT) display, a liquid crystal display (LCD), a light emitting diode (LED) display, a plasma display panel (PDP), a three dimensional (3D) display, or the like, or a combination thereof. In some embodiments, the user device 140 may be connected to one or more components (e.g., the server 110, the acquisition device 130, the storage device 150) of the image retrieval system 100 via the network 120.

The storage device 150 may be configured to store data and/or instructions. The data and/or instructions may be obtained from, for example, the server 110, the acquisition device 130, the user device 140, and/or any other component of the image retrieval system 100. In some embodiments, the storage device 150 may store data and/or instructions that the server 110 may execute or use to perform exemplary methods described in the present disclosure. For example, the storage device 150 may store a target image acquired by the acquisition device 130 or any information (e.g., an extended subset) associated with the target image. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components (e.g., the server 110, the acquisition device 130, the user device 140) of the image retrieval system 100. One or more components of the image retrieval system 100 may access the data or instructions stored in the storage device 150 via the network 120. In some embodiments, the storage device 150 may be directly connected to or communicate with one or more components (e.g., the server 110, the acquisition device 130, the user device 140) of the image retrieval system 100. In some embodiments, the storage device 150 may be part of another component of the image retrieval system 100, such as the server 110, the acquisition device 130, or the user device 140.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 2 is a schematic diagram illustrating exemplary hardware and/or software components of an exemplary computing device according to some embodiments of the present disclosure. In some embodiments, the server 110 may be implemented on the computing device 200. For example, the processing device 112 may be implemented on the computing device 200 and configured to perform functions of the processing device 112 disclosed in this disclosure.

The computing device 200 may be used to implement any component of the image retrieval system 100 as described herein. For example, the processing device 112 may be implemented on the computing device 200, via its hardware, software program, firmware, or a combination thereof. Although only one such computer is shown, for convenience, the computer functions relating to image retrieval as described herein may be implemented in a distributed fashion on a number of similar platforms to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, a read-only memory (ROM) 230, or a random-access memory (RAM) 240, for storing various data files to be processed and/or transmitted by the computing device 200. The computing device 200 may also include program instructions stored in the ROM 230, RAM 240, and/or another type of non-transitory storage medium to be executed by the processor 220. The methods and/or processes of the present disclosure may be implemented as the program instructions. The computing device 200 may also include an I/O component 260, supporting input/output between the computing device 200 and other components. The computing device 200 may also receive programming and data via network communications.

Merely for illustration, only one processor is illustrated in FIG. 2. Multiple processors 220 are also contemplated; thus, operations and/or method steps performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors 220 jointly or separately in the computing device 200 (e.g., a first processor executes step A and a second processor executes step B, or the first and second processors jointly execute steps A and B).

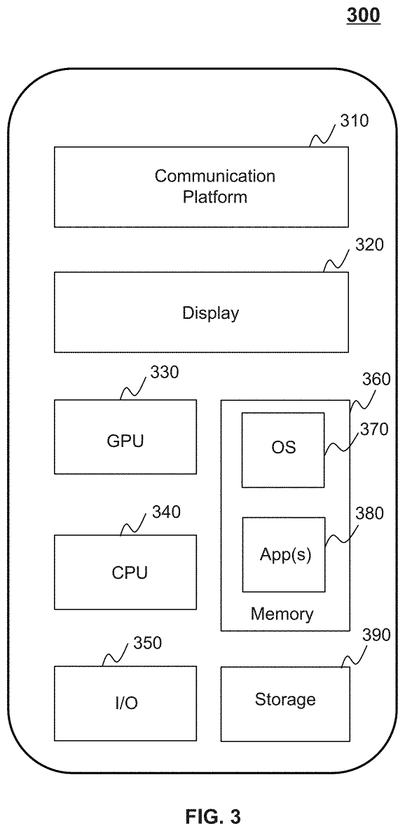

FIG. 3 is a schematic diagram illustrating exemplary hardware and/or software components of an exemplary terminal device according to some embodiments of the present disclosure. In some embodiments, the user device 140 may be implemented on the terminal device 300 shown in FIG. 3. As illustrated in FIG. 3, the terminal device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the terminal device 300.

In some embodiments, an operating system 370 (e.g., iOS™, Android™′ Windows Phone™) and one or more applications (Apps) 380 may be loaded into the memory 360 from the storage 390 in order to be executed by the CPU 340. The applications 380 may include a browser or any other suitable mobile apps for receiving and rendering information relating to image retrieval or other information from the processing device 112. User interactions may be achieved via the I/O 350 and provided to the processing device 112 and/or other components of the image retrieval system 100 via the network 120.

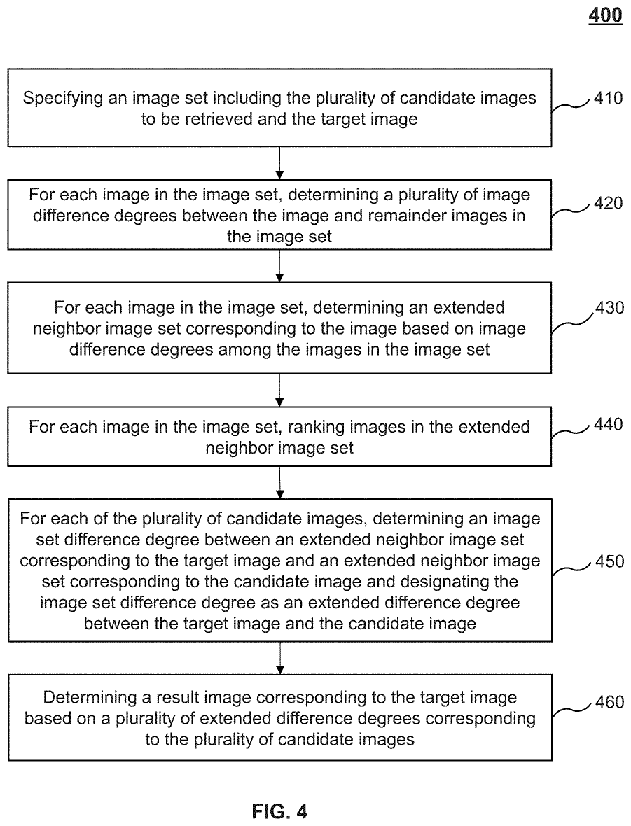

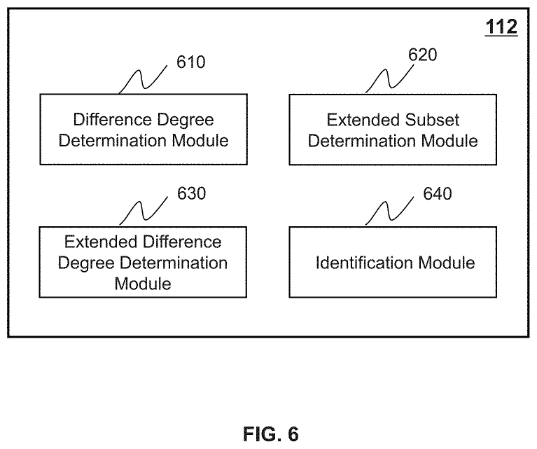

FIG. 4 is a flowchart illustrating an exemplary process for image retrieval according to some embodiments of the present disclosure. In some embodiments, the process 400 may be executed by the image retrieval system 100. For example, the process 400 may be implemented as a set of instructions (e.g., an application) stored in the storage ROM 230 or RAM 240. The processor 220 and/or modules in FIG. 6 may execute the set of instructions, and when executing the instructions, the processor 220 and/or the modules may be configured to perform the process 400. The operations of the illustrated process 400 presented below are intended to be illustrative. In some embodiments, the process 400 may be accomplished with one or more additional operations not described, and/or without one or more of the operations discussed. Additionally, the order in which the operations of the process 400 as illustrated in FIG. 4 and described below is not intended to be limiting.

In 410, an image set including a plurality of candidate images to be retrieved and a target image may be specified. In some embodiments, the image set may be specified by the processing device 112 (e.g., a difference degree determination module 610 illustrated in FIG. 6) (e.g., the processing circuits of the processor 220).

In some embodiments, the plurality of candidate images may be obtained from the acquisition device 130, the user device 140, the storage device 150, an external resource, etc. In some embodiments, the plurality of candidate images may be determined based on one or more image features (e.g., category, color, brightness, size). For example, images corresponding to a same category with the target image may be selected as the plurality of candidate images. As another example, images corresponding to a same object type (e.g., pedestrian) with the target image may be selected as the plurality of candidate images.

In 420, for each image in the image set, a plurality of image difference degrees (also referred to as “difference degrees”) between the image and remainder images in the image set may be determined. In some embodiments, the plurality of image difference degrees may be determined by the processing device 112 (e.g., the difference degree determination module 610) (e.g., the processing circuits of the processor 220).

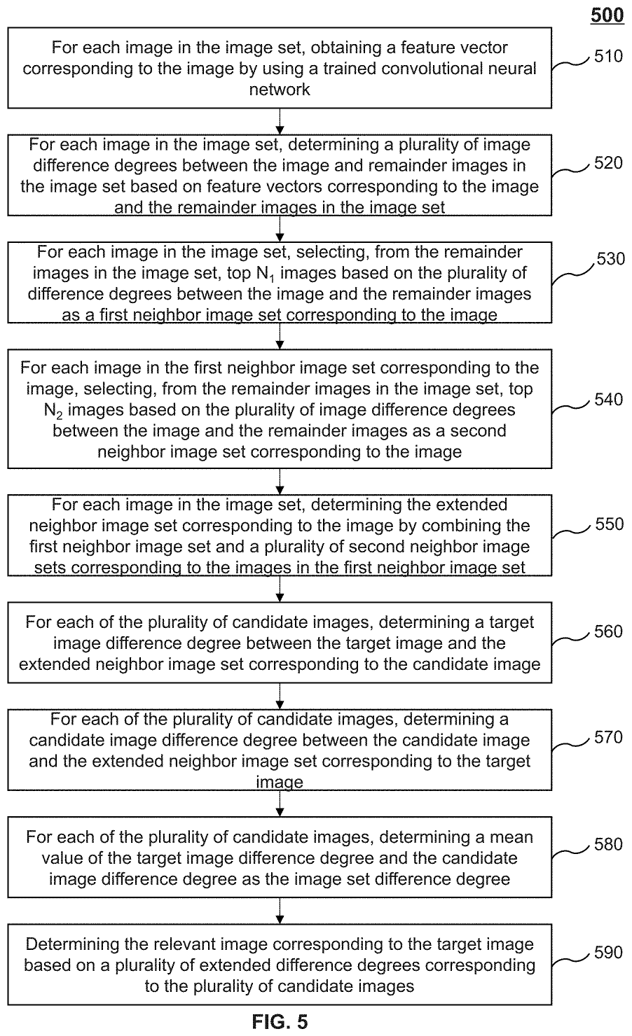

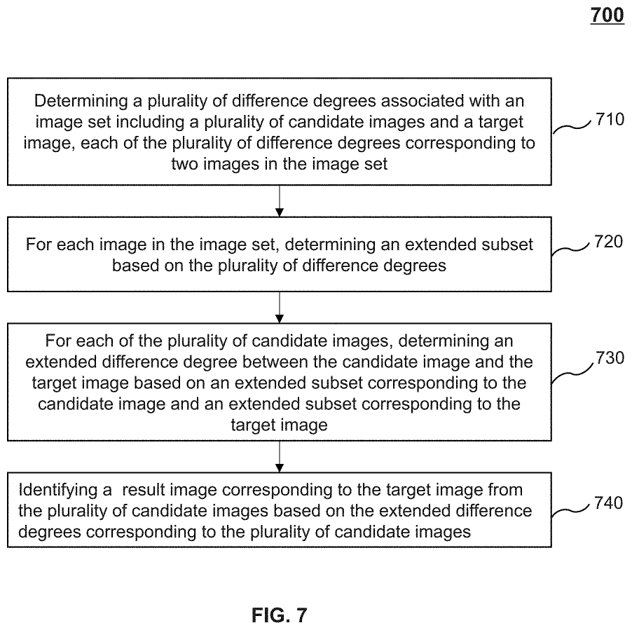

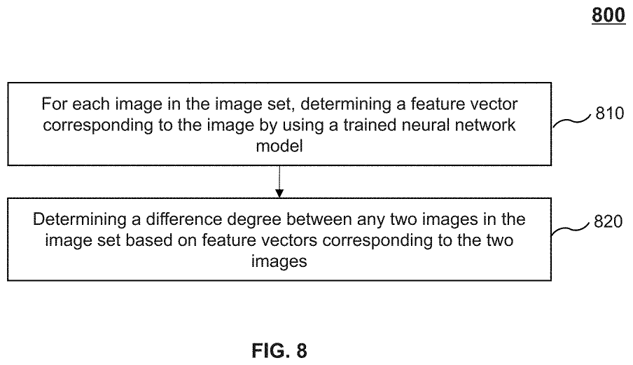

As used herein, take any two images in the image set as an example, the image difference degree may indicate a similarity between the two images. In some embodiments, the image difference degree between the two images may be determined based on feature vectors corresponding to the two images. More descriptions of the image difference degree may be found elsewhere in the present disclosure (e.g., FIG. 5, FIG. 7, FIG. 8, and the descriptions thereof).

In 430, for each image in the image set, an extended neighbor image set (also referred to as “extended subset”) corresponding to the image may be determined based on image difference degrees among the images in the image set. In some embodiments, the extended neighbor image set may be determined by the processing device 112 (e.g., an extended subset determination module 620 illustrated in FIG. 6) (e.g., the processing circuits of the processor 220).

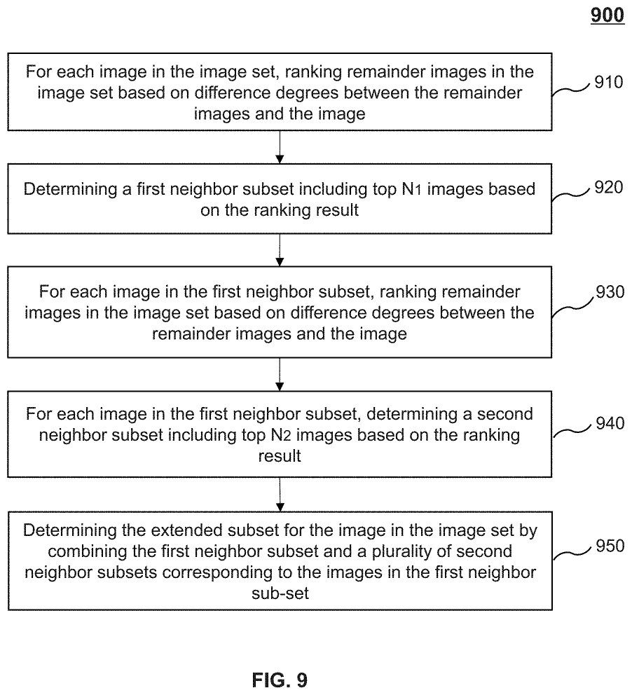

As used herein, taking a specific image (e.g., a candidate image, the target image) in the image set as an example, the extended neighbor image set may be a subset of the image set with the specific image as a center and including images with difference degrees with the specific image satisfying a preset condition. More descriptions regarding determining the extended neighbor image set may be found elsewhere in the present disclosure (e.g., FIG. 5, FIG. 7, FIG. 9, and the descriptions thereof).

In 440, for each image in the image set, images in the extended neighbor image set corresponding to the image may be ranked. In some embodiments, the images in the extended neighbor image set may be ranked by the processing device 112 (e.g., the extended subset determination module 620) (e.g., the processing circuits of the processor 220). In some embodiments, images in the extended neighbor image set may be ranked based on the image difference degrees between the central image and the remainder images in the extended neighbor image set.

In 450, for each of the plurality of candidate images, an image set difference degree between an extended neighbor image set corresponding to the candidate image and an extended neighbor image set corresponding to the target image may be determined and the image set difference degree may be designated as an extended difference degree between the target image and the candidate image. In some embodiments, the image set difference degree may be determined by the processing device 112 (e.g., an extended difference degree determination module 630 illustrated in FIG. 6) (e.g., the processing circuits of the processor 220).

In some embodiments, a first global feature vector of the extended neighbor image set corresponding to the target image and a second global feature vector of the extended neighbor image set corresponding to the candidate image may be determined. Further, the image set difference degree may be determined based on the first global feature vector and the second global feature vector.

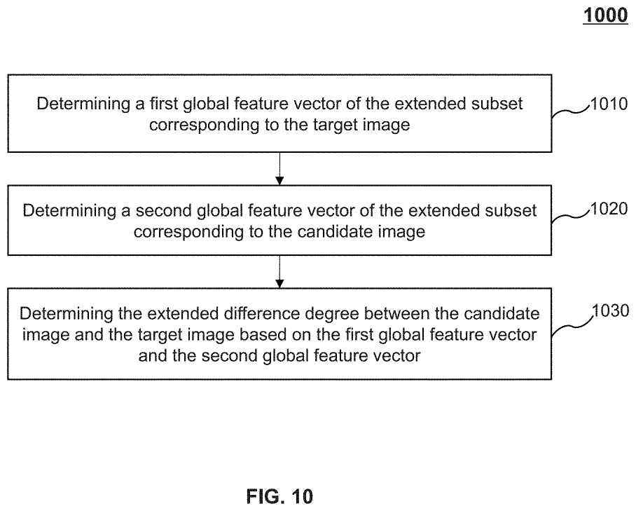

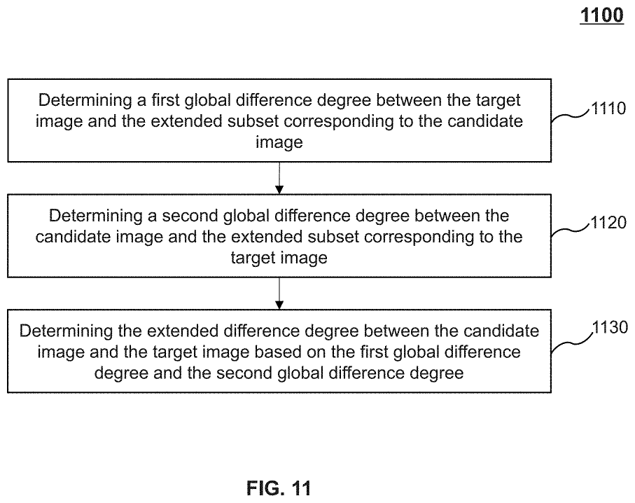

In some embodiments, a target image difference degree between the target image and the extended neighbor image set corresponding to the candidate image may be determined; a candidate image difference degree between the candidate image and the extended neighbor image set corresponding to the target image may be also determined. Further, the image set difference degree may be determined based on the target image difference degree and the candidate image difference degree. For example, the image set difference degree may be determined as a mean value of the target image difference degree and the candidate image difference degree. More descriptions regarding determining the image set difference degree may be found elsewhere in the present disclosure (e.g., FIG. 5, FIG. 7, FIG. 10, FIG. 11, and the descriptions thereof).

In 460, a relevant image (also referred to as “result image”) corresponding to the target image may be determined based on a plurality of extended difference degrees corresponding to the plurality of candidate images. In some embodiments, the result image may be determined by the processing device 112 (e.g., an identification module 640 illustrated in FIG. 6) (e.g., the processing circuits of the processor 220).

In some embodiments, a candidate image with a smallest extended difference degree may be selected from the plurality of candidate images as the result image corresponding to the target image. In some embodiments, a retrieval accuracy may be determined and an image retrieval process may be iteratively performed until the retrieval accuracy no longer increases. More descriptions regarding determining the result image corresponding to the target image may be found elsewhere in the present disclosure (e.g., FIG. 5, FIG. 7, and the descriptions thereof).

According to some embodiments of the present disclosure, any image in the image set is extended to a corresponding extended neighbor image set based on the image difference degrees among the images in the image set. Then for each candidate image, an image set difference degree between an extended neighbor image set corresponding to the candidate image and an extend neighbor image set is determined as an extended difference degree between the target image and the candidate image, which can improve retrieval accuracy.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, for each image in the image set, a further extended neighbor image set may be determined based on the extended difference degrees among the images in the image set. Further, the result image may be identified based the further extended neighbor image sets corresponding to the candidate images and the target image.

FIG. 5 is a flowchart illustrating an exemplary process for image retrieval according to some embodiments of the present disclosure. In some embodiments, the process 500 may be executed by the image retrieval system 100. For example, the process 500 may be implemented as a set of instructions (e.g., an application) stored in the storage ROM 230 or RAM 240. The processor 220 and/or modules in FIG. 6 may execute the set of instructions, and when executing the instructions, the processor 220 and/or the modules may be configured to perform the process 500. The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 510, for each image in the image set, a feature vector corresponding to the image may be obtained by using a trained convolutional neural network. In some embodiments, the feature vector may be obtained by the processing device 112 (e.g., a difference degree determination module 610 illustrated in FIG. 6) (e.g., the processing circuits of the processor 220).

In some embodiments, a hash coding layer may be added between a penultimate layer and the last layer (e.g., a classification layer) in the trained convolutional neural network. For each image in the image set, a hash feature vector corresponding to the image may be obtained by encoding information and/or data (e.g., features) associated with the image using the hash coding layer. For high-dimensional floating-point features of the image, a quantization coding can be implemented by introducing the hash coding layer, which can reduce storage consumption. Further, in order to minimize information loss during the encoding process, a dimension of a hash feature vector output by the hash coding layer is the same as a dimension of an output of the penultimate layer.

In some embodiments, a binary coding layer may be added after the hash coded layer. The binary coding layer may limit one or more elements in the hash feature vector output by the hash coding layer to [0, 1] by using a binarization function (e.g., a sigmoid function). For example, an element in the hash feature vector may be expanded to 1 when the element is greater than or equal to 0.5; an element in the hash feature vector may be compressed to 0 when the element is less than 0.5. Accordingly, a high-dimensional floating-point feature vector is compressed into a binary hash coding feature vector. More descriptions regarding determining the feature vector may be found elsewhere in the present disclosure (e.g., FIG. 8 and the descriptions thereof).

In 520, for each image in the image set, the plurality of image difference degrees between the image and remainder images in the image set may be determined based on feature vectors (e.g., binary hash feature vectors) corresponding to the image and the remainder images. In some embodiments, the plurality of image difference degrees may be determined by the processing device 112 (e.g., the difference degree determination module 610) (e.g., the processing circuits of the processor 220).

In some embodiments, for each image in the image set, the plurality of image difference degrees between the image and the remainder images in the image set may be determined by determining at least one of a Hamming distance, a Euclidean distance, or a cosine distance based on the feature vectors corresponding to the image and the remainder images in the image set. For example, the image difference degree may be determined by determining the Hamming distance, which can improve retrieval speed. More descriptions regarding determining a difference degree between any two images in the image set may be found elsewhere in the present disclosure (e.g., FIG. 8 and the descriptions thereof).

In 530, for each image in the image set, top N₁ images may be selected from the remainder images in the image set based on the plurality of difference degrees between the image and the remainder images as a first neighbor image set (also referred to as “first neighbor subset”) corresponding to the image. In some embodiments, the top N₁ images may be selected by the processing device 112 (e.g., an extended subset determination module 620 illustrated in FIG. 6) (e.g., the processing circuits of the processor 220).

In some embodiments, for each image in the image set, remainder images in the image set may be ranked based on difference degrees between the remainder images and the image. Take the target image as an example, the target image may be indicated as q and the plurality of candidate images may be indicated as gᵢ, wherein i=1˜N and N refers to a count of the plurality of candidate images. Accordingly, the feature vector corresponding to the target image q may be indicated as H_{q}, the plurality of feature vectors corresponding to the plurality of candidate images gᵢ may be indicated as H_{gi}, and the plurality of image difference degrees (e.g., Hamming distances) between the target image q and the plurality of candidate images gᵢ may be indicated as d_{q,gi}. Further, the plurality of candidate images gᵢ (i.e., the remainder images in the image set for the target image) may be ranked based on the plurality of difference degrees d_{q,gi} between the target image q and the plurality of candidate images gᵢ. For example, the plurality of image difference degrees d_{q,gi} may be ranked from small to large as illustrated below:

dᵢₙᵢₜ=[d_{q,g1},d_{q,g′},d_{q,g3′}, . . . ,d_{q,eN}] (1)

where dᵢₙᵢₜ refers to a set illustrating the ranking of the plurality of image difference degrees.

Accordingly, the plurality of candidate images may be ranked based on the plurality of image difference degrees as illustrated below:

gᵢₙᵢₜ=[g₁,g₂,g₃, . . . ,g_{N}] (2)

where gᵢₙᵢₜ refers to a set illustrating the ranking of the plurality of candidate images.

Further, a first neighbor image set including top N₁ (e.g., m) images may be determined based on the ranking result (e.g., gᵢₙᵢₜ) as illustrated below:

E(q,m)={g₁,g₂,g₃, . . . ,gₘ} (3)

where E(q,m) refers to the first neighbor image set. As used herein, N₁ may be a default setting (e.g., 5, 10, 20) of the image retrieval system 100 or may be adjustable under different situations. More descriptions regarding determining the first neighbor image set may be found elsewhere in the present disclosure (e.g., FIG. 9 and the description thereof).

In 540, for each image in the image set, top N₂ images may be selected from the remainder images in the image set based on the plurality of image difference degrees between the image and the remainder images as a second neighbor image set (also referred to as “second neighbor subset”) corresponding to the image. Further, for each image in the first neighbor image set corresponding to the image, a second neighbor image set corresponding to the image may be obtained. In some embodiments, the top N₂ images may be selected by the processing device 112 (e.g., the extended subset determination module 620) (e.g., the processing circuits of the processor 220).

In some embodiments, for each image in the first neighbor image set, remainder images in the image set may be ranked based on difference degrees between the remainder images and the image. Take a specific image (e.g., g₁) in the first neighbor image set E(q,m) as an example, the remainder images in the image set may be ranked based on the difference degrees between the image g and the remainder images. For example, the plurality of image difference degrees may be ranked from small to large. Accordingly, the remainder images may be ranked based on the image difference degrees. Further, a second neighbor image set E(g₁,k) including top N₂ (e.g., k) images may be determined based on the ranking result. As used herein, N₂ may be a default setting (e.g., 5, 10, 20) of the image retrieval system 100 or may be adjustable under different situations. More descriptions regarding determining the second neighbor image set may be found elsewhere in the present disclosure (e.g., FIG. 9 and the description thereof).

In 550, for each image in the image set, an extended neighbor image set corresponding to the image may be determined by combining the first neighbor image set and a plurality of second neighbor image sets corresponding to the images in the first neighbor image set. In some embodiments, the extended neighbor image set may be determined by the processing device 112 (e.g., the extended subset determination module 620) (e.g., the processing circuits of the processor 220).

Still take the target image q as an example, the extended neighbor image set corresponding to the target image q may be determined as illustrated below:

N(q,t)={E(q,m),E(g₁,k),E(g₂,k), . . . ,E(gₘ,k)} (4)

where N(q,t) refers to the extended neighbor image set corresponding to the target image q, E(q,m) refers to the first neighbor image set corresponding to the target image q, E(g₁,k) refers to the second neighbor image set corresponding to the image g₁ in the first neighbor image set E(q,m), and t=m+m*k.

In 560, for each of the plurality of candidate images, a target image difference degree (also referred to as “first global difference degree”) between the target image and the extended neighbor image set corresponding to the candidate image may be determined. In some embodiments, the target image difference degree may be determined by the processing device 112 (e.g., an extended difference degree determination module 630 illustrated in FIG. 6) (e.g., the processing circuits of the processor 220).

In some embodiments, images in the extended neighbor image set corresponding to the candidate image may be ranked (e.g., from small to large) based on the difference degrees (e.g., the Hamming distance) between the images and the target image. For each image in the extended neighbor image set corresponding to the candidate image, a weighting coefficient corresponding to the image may be determined based on a ranking position of the image. The higher the ranking position of the image is, the larger the weighting coefficient corresponding to the image may be. For example, the weighting coefficient corresponding to the image in the extended neighbor image set corresponding to the candidate image may a reciprocal of the ranking position of the image. Further, the target image difference degree may be determined by weighting a plurality of image difference degrees between the target image and the images in the extended neighbor image set corresponding to the candidate image. Take a specific extended neighbor image set N(gᵢ,t) corresponding to a candidate image gᵢ as an example, the target image difference degree may be determined according to formula (5) below:

$${d}_{1} = \frac{1}{{r}_{q , j}} d [ {g}_{i} {E}_{j} , q ] \qquad ( 5 )$$

where d₁ refers to the target image difference degree between the target image q and the extended neighbor image set N(gᵢ,t), gᵢEⱼ refers to a j-th image in the N (g₁,t), d[gᵢEⱼ,q] refers to a Hamming distance between the image gᵢE₁ and the target image q, r_{q,j} refers to a ranking position of the image gᵢEⱼ in the extended neighbor image set, and

$$\frac{1}{{r}_{q , j}}$$

refers to the weighting coefficient corresponding to the image gᵢEⱼ. More descriptions regarding determining the target image difference degree may be found elsewhere in the present disclosure (e.g., FIG. 11 and the description thereof).

In 570, for each of the plurality of candidate images, a candidate image difference degree (also referred to as “second global difference degree”) between the candidate image and the extended neighbor image set corresponding to the target image may be determined. In some embodiments, the candidate image difference degree may be determined by the processing device 112 (e.g., the extended difference degree determination module 630) (e.g., the processing circuits of the processor 220).

In some embodiments, images in the extended neighbor image set corresponding to the target image may be ranked (e.g., from small to large) based on the difference degrees (e.g., the Hamming distance) between the images and the candidate image. For each image in the extended neighbor image set corresponding to the target image, a weighting coefficient corresponding to the image may be determined based on a ranking position of the image. The higher the ranking position of the image is, the larger the weighting coefficient corresponding to the image may be. For example, the weighting coefficient corresponding to the image in the extended neighbor image set corresponding to the target image may a reciprocal of the ranking position of the image. Further, the candidate image difference degree may be determined by weighting a plurality of image difference degrees between the candidate image and the images in the extended neighbor image set corresponding to the target image. For example, the candidate image difference degree may be determined according to formula (6) below:

$${d}_{2} = \frac{1}{{r}_{i , j}} d ( q {E}_{j} , {g}_{i} ) \qquad ( 6 )$$

where d₂ refers to the candidate image difference degree between a candidate image gᵢ and the extended neighbor image set N(q,t), qEⱼ refers to a j-th image in the N(q,t), d(qEⱼ,gᵢ) refers to a Hamming distance between the image qEⱼ and the candidate image gᵢ, r_{i,j} refers to a ranking position of the image qEⱼ in the extended neighbor image set, and

$$\frac{1}{{r}_{i , j}}$$

refers to the weighting coefficient corresponding to the image qEⱼ. More descriptions regarding determining the candidate image difference degree may be found elsewhere in the present disclosure (e.g., FIG. 11 and the description thereof).

In 580, for each of the plurality of candidate images, a mean value of the target image difference degree and the candidate image difference degree may be determined as an image set difference degree. Further, the image set difference degree may be designated as an extended difference degree between the target image and the candidate image. In some embodiments, the mean value of the target image difference degree and the candidate image difference degree may be determined by the processing device 112 (e.g., the extended difference degree determination module 630) (e.g., the processing circuits of the processor 220).

In some embodiments, the image set difference degree may be determined according to formula (7) below:

$${d}_{e} ( q , {g}_{i} ) = \frac{1}{2 t} {\sum }_{j = 1}^{t} ( {d}_{1} + {d}_{2} ) \qquad ( 7 )$$

where dₑ(q,gᵢ) refers to the image set difference degree between the candidate image gᵢ and the target image q, d₁ refers to the target image difference degree, d₂ refers to the candidate image difference degree, and t=m+m*k. More descriptions regarding determining the extended difference degree may be found elsewhere in the present disclosure (e.g., FIG. 10, FIG. 11, and the descriptions thereof).

According to some embodiments of the present disclosure, the weighting coefficient corresponding to each image in the extended neighbor image set (e.g., the extended neighbor image set corresponding to the candidate image, the extended neighbor image set corresponding to the target image) is determined based on the ranking position of the image, which may be associated with a correlation degree between two images (e.g., the target image and each image in the extended neighbor image set corresponding to the candidate image, the candidate image and each image in the extended neighbor image set corresponding to the target image), thereby reducing an interference caused by possible factors (e.g., m, k) and improving a stability of the image retrieval.

In 590, a result image corresponding to the target image may be determined based on a plurality of extended difference degrees corresponding to the plurality of candidate images. In some embodiments, the result image may be determined by the processing device 112 (e.g., an identification module 640 illustrated in FIG. 6) (e.g., the processing circuits of the processor 220).

As described in connection with operation 470, a candidate image with a smallest extended difference degree may be selected from the plurality of candidate images as the result image corresponding to the target image. In some embodiments, after the result image is determined, the result image may be transmitted to a user device (e.g., the user device 140) to be displayed or to be further processed.

According to some embodiments of the present disclosure, the target image difference degree and the candidate image difference degree may be determined by performing a weighting operation, which can reduce the impact of predetermined parameters (e.g., m, k), thereby improving a stability and accuracy of image retrieval.

In some embodiments, when the target image and each of the plurality of candidate images include category tags (e.g., “cat,” “male”), a retrieval accuracy may be determined based on the category tags. As used herein, a category tag of an image may indicate category information of the image. For example, a category tag of an image with an object “cat” may be “cat” a category tag of an image with an object “male” may be “male.” According to the category tags of the target image and the plurality of candidate images, the retrieval result can be evaluated. For example, if the category tag of the target image is the same as the category tag of the result image, the retrieval accuracy of the retrieval result may be relatively high (e.g., considered as 1); if the category tag of the target image is different from the category tag of the result image, the retrieval accuracy of the retrieval result may be relatively low. In some embodiments, it is assumed that the target image correspond to multiple categories, an average retrieval accuracy may be determined based on multiple individual retrieval accuracies corresponding to the multiple categories.

In some embodiments, after the retrieval accuracy corresponding to a current image retrieval process is determined, a comparison between the current retrieval accuracy (or a current average retrieval accuracy) and a previous retrieval accuracy (or a previous average retrieval accuracy) obtained in a previous image retrieval process may be performed. If the retrieval accuracy is not change (e.g., the current retrieval accuracy is equal to (or substantially equal to) the previous retrieval accuracy), the image retrieval process may be ended and the result image may be transmitted to the user device 140. If the retrieval accuracy is increasing (e.g., the retrieval accuracy is higher than the previous retrieval accuracy), a next image retrieval process may be performed. In some embodiments, the image retrieval process may be iteratively performed until the retrieval accuracy no longer increases. More descriptions regarding iteratively performing an image retrieval process may be found elsewhere in the present disclosure (e.g., FIG. 7 and the description thereof).

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 6 is a block diagram illustrating an exemplary processing device according to some embodiments of the present disclosure. The processing device 112 may include a difference degree determination module 610, an extended subset determination module 620, an extended difference degree determination module 630, and an identification module 640.

The difference degree determination module 610 may be configured to determine a plurality of difference degrees associated with an image set including a plurality of candidate images and a target image. In some embodiments, for each image in the image set, the difference degree determination module 610 may determine a feature vector corresponding to the image by using a trained neural network model. Further, the difference degree determination module 610 may determine a difference degree between any two images in the image set based on feature vectors corresponding to the two images. For example, the difference degree determination module 610 may determine the difference degree between any two images in the image set by determining at least one of a Hamming distance, a Euclidean distance, or a cosine distance based on the feature vectors corresponding to the two images.

The extended subset determination module 620 may be configured to determine an extended subset for each image in the image set based on the plurality of difference degrees. In some embodiments, for each image in the image set, the extended subset determination module 620 may rank remainder images in the image set based on the difference degrees between the remainder images and the image and determine a first neighbor subset corresponding to the image based on the ranking result. Further, for each image in the first neighbor subset, the extended subset determination module 620 may rank remainder images in the image set based on the difference degrees between the remainder images and the image and determine a second neighbor subset corresponding to the image based on the ranking result. Then the extended subset determination module 620 may determine the extended subset corresponding to the image based on the first neighbor subset and a plurality of second neighbor subsets corresponding to the images in the first neighbor subset.

The extended difference degree determination module 630 may be configured to, for each of the plurality of candidate images, determine an extended difference degree between the candidate image and the target image based on an extended subset corresponding to the candidate image and an extended subset corresponding to the target image. In some embodiments, the extended difference degree determination module 630 may determine a first global feature vector of the extended neighbor image set corresponding to the target image and a second global feature vector of the extended neighbor image set corresponding to the candidate image. Further, the extended difference degree determination module 630 determine the image set difference degree based on the first global feature vector and the second global feature vector. In some embodiments, the extended difference degree determination module 630 may determine a first global difference degree between the target image and the extended subset corresponding to the candidate image and a second global difference degree between the candidate image and the extended subset corresponding to the target image. Further the extended difference degree determination module 630 may determine the extended difference degree based on the first global difference degree and the second global difference degree.

The identification module 640 may be configured to identify a result image corresponding to the target image from the plurality of candidate images based on the extended difference degrees corresponding to the plurality of candidate images. In some embodiments, the identification module 640 may select a candidate image with a smallest extended difference degree from the plurality of candidate images as the result image corresponding to the target image. In some embodiments, the identification module 640 may identify one or more candidate images with an extended difference degree less than a difference degree threshold (which may be a default setting of the image retrieval system 100 or may be adjustable under different situations) as one or more result images corresponding to the target image.

The modules in the processing device 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units.

For example, the difference degree determination module 610 and the extended subset determination module 620 may be combined as a single module which may both determine the plurality of difference degrees associated with the image set and determine the extended subset for each image in the image set based on the plurality of difference degrees. As another example, the processing device 112 may also include a transmission module configured to transmit signals (e.g., electrical signals, electromagnetic signals) to one or more components (e.g., the user device 140) of the image retrieval 100 to display the result image corresponding to the target image. As further another example, the processing device 112 may include a storage module (not shown) used to store information and/or data (e.g., the image set, the target image, the plurality of candidate images, the result image) associated with the image retrieval.

FIG. 7 is a flowchart illustrating an exemplary process for image retrieval according to some embodiments of the present disclosure. In some embodiments, the process 700 may be implemented as a set of instructions (e.g., an application) stored in the storage ROM 230 or RAM 240. The processor 220 and/or the modules in FIG. 6 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting.

In 710, the processing device 112 (e.g., the difference degree determination module 610) (e.g., the processing circuits of the processor 220) may determine a plurality of difference degrees associated with an image set including a plurality of candidate images and a target image.

As described in connection with operation 410, the processing device 112 may obtain the plurality of candidate images from the acquisition device 130, the user device 140, the storage device 150, an external resource, etc. Further, the processing device 112 may specify the image set by integrating the target image and the plurality of candidate images into a set.

In some embodiments, as described in connection with operation 510 and operation 520, for each image in the image set, the processing device 112 may obtain a plurality of features (e.g., category, color, brightness, size) of the image and determine a feature vector corresponding to the image based on the plurality of features by using a trained neural network model (e.g., a convolutional neural network model). Further, the processing device 112 may determine a difference degree between any two images in the image set based on feature vectors corresponding to the two images. More descriptions regarding determining a difference degree between any two images in the image set may be found elsewhere in the present disclosure (e.g., FIG. 8 and the description thereof).

In 720, for each image in the image set, the processing device 112 (e.g., the extended subset determination module 620) (e.g., the processing circuits of the processor 220) may determine an extended subset based on the plurality of difference degrees.

As described in connection with operation 530, operation 540, and/or operation 550, for each image in the image set, the processing device 112 may rank remainder images in the image set based on the difference degrees between the remainder images and the image and determine a first neighbor subset corresponding to the image based on the ranking result. Further, for each image in the first neighbor subset, the processing device 112 may rank remainder images in the image set based on the difference degrees between the remainder images and the image and determine a second neighbor subset corresponding to the image based on the ranking result. Then the processing device 112 may determine the extended subset corresponding to the image based on the first neighbor subset and a plurality of second neighbor subsets corresponding to the images in the first neighbor subset. More descriptions regarding determining the extended subset may be found elsewhere in the present disclosure (e.g., FIG. 9 and the description thereof).

In 730, for each of the plurality of candidate images, the processing device 112 (e.g., the extended difference degree determination module 630) (e.g., the processing circuits of the processor 220) may determine an extended difference degree between the candidate image and the target image based on an extended subset corresponding to the candidate image and an extended subset corresponding to the target image.

As described in connection with operation 450, the processing device 112 may determine a first global feature vector of the extended neighbor image set corresponding to the target image and a second global feature vector of the extended neighbor image set corresponding to the candidate image. Further, the processing device 112 may determine the image set difference degree based on the first global feature vector and the second global feature vector.

As described in connection with operation 560, operation 570, and/or operation 580, the processing device 112 may determine a first global difference degree between the target image and the extended subset corresponding to the candidate image and a second global difference degree between the candidate image and the extended subset corresponding to the target image. Further the processing device 112 may determine the extended difference degree based on the first global difference degree and the second global difference degree. More descriptions of determining the extended difference degree may be found elsewhere in the present disclosure (e.g., FIG. 10, FIG. 11, and the descriptions thereof).

In 740, the processing device 112 (e.g., the identification module 640) (e.g., the processing circuits of the processor 220) may identify a result image corresponding to the target image from the plurality of candidate images based on the extended difference degrees corresponding to the plurality of candidate images.

In some embodiments, as described in connection with operation 460, the processing device 112 may select a candidate image with a smallest extended difference degree from the plurality of candidate images as the result image corresponding to the target image.

In some embodiments, the processing device 112 may identify one or more candidate images with an extended difference degree less than a difference degree threshold (which may be a default setting of the image retrieval system 100 or may be adjustable under different situations) as one or more result images corresponding to the target image.

In some embodiments, after identifying the result image, the processing device 112 may identify a first category (e.g., a category of an object, for example, “male,” “female,” “cat,” “dog,” duck”) of the target image and a second category of the result image. For example, the processing device 112 may identify the first category and the second category from category tags included in the images. Further, as described in connection with operation 590, the processing device 112 may determine a retrieval accuracy based on the first category and the second category. For example, if the second category is the same as the first category, the processing device 112 may determine the retrieval accuracy as “1;” whereas, if the second category is different from the first category, the processing device 112 may determine the retrieval accuracy as “0.”

In some embodiments, the first category of the target image may include multiple specific categories. In this situation, the processing device 112 may determine an individual retrieval accuracy corresponding to each of the multiple specific categories and determine a global retrieval accuracy based on multiple individual retrieval accuracies. For example, it is assumed that the first category includes “cat,” “female,” and “male,” the second category includes “cat” and “male.” The processing device 112 may determine an individual retrieval accuracy (which may be “1”) corresponding to “cat,” an individual retrieval accuracy (which may be “0”) corresponding to “female,” and an individual retrieval accuracy (which may be “1”) corresponding to “male.” Further, the processing device 112 may determine the global retrieval accuracy based on an average value (e.g., ⅔) of the multiple individual retrieval accuracies.

In some embodiments, the processing device 112 may determine the retrieval accuracy based on a first feature (e.g., a count of objects, color, brightness, size) of the target image and a second feature of the result image. For example, the processing device 112 may determine the retrieval accuracy based on a comparison result (e.g., a similarity, a consistency) of the first feature and the second feature.

After determining the retrieval accuracy, the processing device 112 may iteratively perform an image retrieval process until the retrieval accuracy satisfies a preset condition. For example, the processing device 112 may determine whether a current retrieval accuracy is equal to (or substantially equal to) a previous retrieval accuracy. In response to determining that the current retrieval accuracy is equal to (or substantially equal to) the previous retrieval accuracy (which indicates that the retrieval accuracy no longer increase), the processing device 112 may end the iterative retrieval process. As another example, the processing device 112 may determine whether the retrieval accuracy is larger than a predetermined threshold. In response to determining that the retrieval accuracy is larger than the predetermined threshold, the processing device 112 may end the iterative retrieval process. The predetermined threshold may be a default setting (e.g., 80%, 90%, 95%, 98%) of the image retrieval system 100 or may be adjustable under different situations.

In some embodiments, the processing device 112 may transmit the finally identified result image to the user device 140 to be displayed or to be further processed.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 700. In the storing operation, the processing device 112 may store information and/or data (e.g., the image set, the target image, the plurality of candidate images, the result image) associated with the image retrieval in a storage device (e.g., the storage device 150) disclosed elsewhere in the present disclosure. As another example, operation 710 and operation 720 may be combined into a single operation in which the processing device 112 may both determine the plurality of difference degrees associated with the image set and determine the extended subset for each image in the image set based on the plurality of difference degrees.

FIG. 8 is a flowchart illustrating an exemplary process for determining a difference degree according to some embodiments of the present disclosure. In some embodiments, the process 800 may be implemented as a set of instructions (e.g., an application) stored in the storage ROM 230 or RAM 240. The processor 220 and/or the modules in FIG. 6 may execute the set of instructions, and when executing the instructions, the processor 220 and/or the modules may be configured to perform the process 800. The operations of the illustrated process presented below are intended to be illustrative. In some embodiments, the process 800 may be accomplished with one or more additional operations not described and/or without one or more of the operations herein discussed. Additionally, the order in which the operations of the process as illustrated in FIG. 8 and described below is not intended to be limiting.

In 810, for each image in the image set, the processing device 112 (e.g., the difference degree determination module 610) (e.g., the processing circuits of the processor 220) may determine a feature vector corresponding to the image by using a trained neural network model (e.g., a trained convolutional neural network).

As described elsewhere in the present disclosure, the neural network model may include a hash coding layer and a binary coding layer. As described in connection with operation 510 and operation 520, for each image in the image set, the processing device 112 may obtain a plurality of features (e.g., category, color, brightness, size) of the image and determine a hash feature vector corresponding to the image by encoding the plurality of features of the image using the hash coding layer. Further, the processing device 112 may determine the feature vector (i.e., a binary hash coding feature vector) corresponding to the image by processing (e.g., compressing, expanding) the hash feature vector using the binary coding layer.

In 820, the processing device 112 (e.g., the difference degree determination module 610) (e.g., the processing circuits of the processor 220) may determine a difference degree between any two images in the image set based on feature vectors corresponding to the two images.

In some embodiments, the processing device 112 may determine the difference degree between any two images in the image set by determining at least one of a Hamming distance, a Euclidean distance, or a cosine distance based on the feature vectors corresponding to the two images. For example, the processing device 112 may designate the Hamming distance between two feature vectors corresponding to any two images in the image set as the difference degree between the two images. As used herein, the Hamming distance between two feature vectors may refer to a count of positions where elements corresponding to the two feature vectors are different. For example, the Hamming distance between a feature vector “(1, 0, 0, 1, 1, 0)” and a feature vector “(1, 1, 0, 1, 0, 0)” may be 2.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 9 is a flowchart illustrating an exemplary process for determining an extended subset according to some embodiments of the present disclosure. In some embodiments, the process 900 may be implemented as a set of instructions (e.g., an application) stored in the storage ROM 230 or RAM 240. The processor 220 and/or the modules in FIG. 6 may execute the set of instructions, and when executing the instructions, the processor 220 and/or the modules may be configured to perform the process 900. The operations of the illustrated process presented below are intended to be illustrative. In some embodiments, the process 900 may be accomplished with one or more additional operations not described and/or without one or more of the operations herein discussed. Additionally, the order in which the operations of the process as illustrated in FIG. 9 and described below is not intended to be limiting.

In 910, for each image in the image set, the processing device 112 (e.g., the extended subset determination module 620) (e.g., the processing circuits of the processor 220) may rank remainder images in the image set based on difference degrees (e.g., Hamming distances) between the remainder images and the image.

For example, for the target image, the processing device 112 may rank Hamming distances between the plurality of the candidate images and the target image from small to large. Further, the processing device 112 may rank the plurality of the candidate images based on the ranking result of the Hamming distances.

As another example, for each of the plurality of the candidate images, the processing device 112 may rank Hamming distances between remainder images in the image set and the candidate image from small to large. Further, the processing device 112 may rank the remainder images in the image set based on the ranking result of the Hamming distances.

In 920, for each image in the image set, the processing device 112 (e.g., the extended subset determination module 620) (e.g., the processing circuits of the processor 220) may determine a first neighbor subset including top N₁ images based on the ranking result. In some embodiments, N₁ may be a default setting (e.g., m) of the image retrieval system 100 or may be adjustable under different situations.

In 930, for each image in the first neighbor subset, the processing device 112 (e.g., the extended subset determination module 620) (e.g., the processing circuits of the processor 220) may rank remainder images in the image set based on difference degrees (e.g., Hamming distances) between the remainder images and the image.

For example, for each image (i.e., a candidate image) in a first neighbor subset corresponding to the target image, the processing device 112 may rank Hamming distances between remainder candidate images in the image set and image from small to large. Further, the processing device 112 may rank remainder candidate images in the image set based on the ranking result of the Hamming distances.

As another example, for each image in a first neighbor subset corresponding to a specific candidate image, the processing device 112 may rank Hamming distances between remainder images in the image set and the image from small to large. Further, the processing device 112 may rank the remainder images based on the ranking result of the Hamming distances.

In 940, for each image in the first neighbor subset, the processing device 112 (e.g., the extended subset determination module 620) (e.g., the processing circuits of the processor 220) may determine a second neighbor subset including top N₂ images based on the ranking result. In some embodiments, N₂ may be a default setting (e.g., k) of the image retrieval system 100 or may be adjustable under different situations.

In 950, the processing device 112 (e.g., the extended subset determination module 620) (e.g., the processing circuits of the processor 220) may determine the extended subset for the image in the image set by combining the first neighbor subset and a plurality of second neighbor subsets corresponding to the images in the first neighbor sub-set.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 10 is a flowchart illustrating an exemplary process for determining an extended difference degree according to some embodiments of the present disclosure. In some embodiments, the process 1000 may be implemented as a set of instructions (e.g., an application) stored in the storage ROM 230 or RAM 240. The processor 220 and/or the modules in FIG. 6 may execute the set of instructions, and when executing the instructions, the processor 220 and/or the modules may be configured to perform the process 1000. The operations of the illustrated process presented below are intended to be illustrative. In some embodiments, the process 1000 may be accomplished with one or more additional operations not described and/or without one or more of the operations herein discussed. Additionally, the order in which the operations of the process as illustrated in FIG. 10 and described below is not intended to be limiting.

In 1010, the processing device 112 (e.g., the extended difference degree determination module 630) (e.g., the processing circuits of the processor 220) may determine a first global feature vector of the extended subset corresponding to the target image.

In some embodiments, as described in connection with operation 510 and operation 810, for each image in the image set, the processing device 112 may determine a feature vector corresponding to the image by using a trained neural network model. The processing device 112 may determine the first global feature vector of the extended subset corresponding to the target image based on feature vectors of images in the extended subset corresponding to the target image. For example, the processing device 112 may determine a sum of the feature vectors of the images in the extended subset corresponding to the target image as the first global feature vector. As another example, except the target image, the processing device 112 may rank (e.g., from small to large) remainder images in the extended subset corresponding to the target image based on difference degrees between the remainder images in the extended subset and the target image. Further, the processing device 112 may determine the first global feature vector by combining the feature vectors of the images in the extended subset corresponding to the target image in an order (e.g., the target image first, the remainder images in order) of the ranking result.

In 1020, for each of the plurality of candidate images, the processing device 112 (e.g., the extended difference degree determination module 630) (e.g., the processing circuits of the processor 220) may determine a second global feature vector of the extended subset corresponding to the candidate image.

As described above, the processing device 112 may determine the second global feature vector of the extended subset corresponding to the candidate image based on feature vectors of the images in the extended subset corresponding to the candidate image in a similar way.

In 1030, for each of the plurality of candidate images, the processing device 112 (e.g., the extended difference degree determination module 630) (e.g., the processing circuits of the processor 220) may determine the extended difference degree between the candidate image and the target image based on the first global feature vector and the second global feature vector.

In some embodiments, the processing device 112 may determine the extended difference degree between the candidate image and the target image by determining at least one of a Hamming distance, a Euclidean distance, or a cosine distance based on the first global feature vector and the second global feature vector.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 11 is a flowchart illustrating an exemplary process for determining an extended difference degree according to some embodiments of the present disclosure. In some embodiments, the process 1100 may be implemented as a set of instructions (e.g., an application) stored in the storage ROM 230 or RAM 240. The processor 220 and/or the modules in FIG. 6 may execute the set of instructions, and when executing the instructions, the processor 220 and/or the modules may be configured to perform the process 1100. The operations of the illustrated process presented below are intended to be illustrative. In some embodiments, the process 1100 may be accomplished with one or more additional operations not described and/or without one or more of the operations herein discussed. Additionally, the order in which the operations of the process as illustrated in FIG. 11 and described below is not intended to be limiting.

In 1110, for each of the plurality of candidate images, the processing device 112 (e.g., the extended difference degree determination module 630) (e.g., the processing circuits of the processor 220) may determine a first global difference degree between the target image and the extended subset corresponding to the candidate image.

In some embodiments, for each image in the extended subset corresponding to the candidate image, the processing device 112 may determine a weighting coefficient corresponding to the image based on a difference degree between the image and the target image. For example, the weighting coefficient corresponding to the image may be negatively correlated with the difference degree between the image and the target image. Further, the processing device 112 may determine the first global difference degree by weighting a plurality of difference degrees between the target image and the images in the extended subset corresponding to the candidate image.

In 1120, for each of the plurality of candidate images, the processing device 112 (e.g., the extended difference degree determination module 630) (e.g., the processing circuits of the processor 220) may determine a second global difference degree between the candidate image and the extended subset corresponding to the target image.

In some embodiments, for each image in the extended subset corresponding to the target image, the processing device 112 may determine a weighting coefficient corresponding to the image based on a difference degree between the image and the candidate image. For example, the weighting coefficient corresponding to the image may be negatively correlated with the difference degree between the image and the candidate image. Further, the processing device 112 may determine the second global difference degree between the candidate image and the extended subset corresponding to the target image by weighting a plurality of difference degrees between the candidate image and images in the extended subset corresponding to the target image.

In 1130, for each of the plurality of candidate images, the processing device 112 (e.g., the extended difference degree determination module 630) (e.g., the processing circuits of the processor 220) may determine the extended difference degree between the candidate image and the target image based on the first global difference degree and the second global difference degree.

For example, the processing device 112 may determine a mean value (or a weighted mean value) of the first global difference degree and the second global difference degree as the extended difference degree between the target image and the candidate image. As another example, the processing device 112 may determine any mathematical result associated with the first global difference degree and the second global difference degree as the extended difference degree between the target image and the candidate image.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

The present disclosure may also provide a computer storage medium storing a computer program thereon. When executing by a processor, the computer program may direct the processor to perform a process (e.g., process 400, process 500, process 700, process 800, process 900, process 1000, process 1100) described elsewhere in the present disclosure.

In some embodiments, the computer storage medium may include a U disk, a mobile hard disk, a read-only memory, a random access memory, a magnetic disk, an optical disk, a server that stores the computer program, or the like, or any combination thereof. In some embodiments, the server may execute the computer program or transmit the computer program to other devices for executing. In some embodiments, the computer storage medium may be a combination of a plurality of physical entities, such as a plurality of servers, a server and a storage, or a storage and a mobile hard disk.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations thereof, are not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-10. (canceled)

11. A system for image retrieval, comprising:
at least one storage medium including a set of instructions; and
at least one processor in communication with the at least one storage medium, wherein when executing the set of instructions, the at least one processor is directed to cause the system to:
determine a plurality of difference degrees associated with an image set including a plurality of candidate images and a target image, each of the plurality of difference degrees corresponding to two images in the image set;
for each image in the image set, determine an extended subset based on the plurality of difference degrees;
for each of the plurality of candidate images, determine an extended difference degree between the candidate image and the target image based on an extended subset corresponding to the candidate image and an extended subset corresponding to the target image; and
identify a result image corresponding to the target image from the plurality of candidate images based on the extended difference degrees corresponding to the plurality of candidate images.

12. The system of claim 11, wherein to determine the plurality of difference degrees associated with the image set including the plurality of candidate images and the target image, the at least one processor is directed to cause the system further to:
for each image in the image set, determine a feature vector corresponding to the image by using a trained neural network model; and
determine a difference degree between any two images in the image set based on feature vectors corresponding to the two images.

13. The system of claim 12, wherein
the neural network model includes a hash coding layer and a binary coding layer, and
the feature vector is a binary hash coding feature vector.

14. The system of claim 12, wherein to determine the difference degree between any two images in the image set based on the feature vectors corresponding to the two images, the at least one processor is directed to cause the system further to:
determine the difference degree between any two images in the image set by determining at least one of a Hamming distance, a Euclidean distance, or a cosine distance based on the feature vectors corresponding to the two images.

15. The system of claim 11, wherein for each image in the image set, to determine the extended subset based on the plurality of difference degrees, the at least one processor is directed to cause the system further to:
for each image in the image set, rank remainder images in the image set based on difference degrees between the remainder images and the image;
determine a first neighbor subset including top N₁ images based on the ranking result;
for each image in the first neighbor subset,
rank remainder images in the image set based on difference degrees between the remainder images and the image; and
determine a second neighbor subset including top N₂ images based on the ranking result;
determine the extended subset for the image in the image set by combining the first neighbor subset and a plurality of second neighbor subsets corresponding to the images in the first neighbor subset.

16. The system of claim 11, wherein for each of the plurality of candidate images, to determine the extended difference degree between the candidate image and the target image based on the extended subset corresponding to the candidate image and the extended subset corresponding to the target image, the at least one processor is directed to cause the system further to:
determine a first global feature vector of the extended subset corresponding to the target image;
determine a second global feature vector of the extended subset corresponding to the candidate image; and
determine the extended difference degree between the candidate image and the target image based on the first global feature vector and the second global feature vector.

17. The system of claim 11, wherein for each of the plurality of candidate images, to determine the extended difference degree between the candidate image and the target image based on the extended subset corresponding to the candidate image and the extended subset corresponding to the target image, the at least one processor is directed to cause the system further to:
determine a first global difference degree between the target image and the extended subset corresponding to the candidate image;
determine a second global difference degree between the candidate image and the extended subset corresponding to the target image; and
determine the extended difference degree between the candidate image and the target image based on the first global difference degree and the second global difference degree.

18. The system of claim 17, wherein
to determine the first global difference degree between the target image and the extended subset corresponding to the candidate image, the at least one processor is directed to cause the system further to:
determine the first global difference degree between the target image and the extended subset corresponding to the candidate image by weighting a plurality of difference degrees between the target image and images in the extended subset corresponding to the candidate image, wherein for each of the images in the extended subset corresponding to the candidate image, a weighting coefficient corresponding to the image is negatively correlated with a difference degree between the image and the target image; and
to determine the second global difference degree between the candidate image and the extended subset corresponding to the target image, the at least one processor is directed to cause the system further to:
determine the second global difference degree between the candidate image and the extended subset corresponding to the target image by weighting a plurality of difference degrees between the candidate image and images in the extended subset corresponding to the target image, wherein for each of the images in the extended subset corresponding to the target image, a weighting coefficient corresponding to the image is negatively correlated with a difference degree between the image and the candidate image.

19. The system of claim 11, wherein the at least one processor is directed to cause the system further to:
identify a first category of the target image and a second category of the result image;
determine a retrieval accuracy based on the first category and the second category; and
iteratively perform an image retrieval process until the retrieval accuracy satisfies a preset condition.

20. A method implemented on a computing device including at least one processor, at least one storage medium, and a communication platform connected to a network, the method comprising:
determining a plurality of difference degrees associated with an image set including a plurality of candidate images and a target image, each of the plurality of difference degrees corresponding to two images in the image set;
for each image in the image set, determining an extended subset based on the plurality of difference degrees;
for each of the plurality of candidate images, determining an extended difference degree between the candidate image and the target image based on an extended subset corresponding to the candidate image and an extended subset corresponding to the target image; and
identifying a result image corresponding to the target image from the plurality of candidate images based on the extended difference degrees corresponding to the plurality of candidate images.

21. The method of claim 20, wherein the determining the plurality of difference degrees associated with the image set including the plurality of candidate images and the target image includes:
for each image in the image set, determining a feature vector corresponding to the image by using a trained neural network model; and
determining a difference degree between any two images in the image set based on feature vectors corresponding to the two images.

22. The method of claim 21, wherein
the neural network model includes a hash coding layer and a binary coding layer, and
the feature vector is a binary hash coding feature vector.

23. The method of claim 21, wherein the determining the difference degree between any two images in the image set based on the feature vectors corresponding to the two images includes:
determining the difference degree between any two images in the image set by determining at least one of a Hamming distance, a Euclidean distance, or a cosine distance based on the feature vectors corresponding to the two images.

24. The method of claim 20, wherein for each image in the image set, the determining the extended subset based on the plurality of difference degrees includes:
for each image in the image set, ranking remainder images in the image set based on difference degrees between the remainder images and the image;
determining a first neighbor subset including top N₁ images based on the ranking result;
for each image in the first neighbor subset,
ranking remainder images in the image set based on difference degrees between the remainder images and the image; and
determining a second neighbor subset including top N₂ images based on the ranking result;
determining the extended subset for the image in the image set by combining the first neighbor subset and a plurality of second neighbor subsets corresponding to the images in the first neighbor sub-set.

25. The method of claim 20, wherein for each of the plurality of candidate images, the determining the extended difference degree between the candidate image and the target image based on the extended subset corresponding to the candidate image and the extended subset corresponding to the target image includes:
determining a first global feature vector of the extended subset corresponding to the target image;
determining a second global feature vector of the extended subset corresponding to the candidate image; and
determining the extended difference degree between the candidate image and the target image based on the first global feature vector and the second global feature vector.

26. The method of claim 20, wherein for each of the plurality of candidate images, the determining the extended difference degree between the candidate image and the target image based on the extended subset corresponding to the candidate image and the extended subset corresponding to the target image includes:
determining a first global difference degree between the target image and the extended subset corresponding to the candidate image;
determining a second global difference degree between the candidate image and the extended subset corresponding to the target image; and
determining the extended difference degree between the candidate image and the target image based on the first global difference degree and the second global difference degree.

27. The method of claim 26, wherein
the determining the first global difference degree between the target image and the extended subset corresponding to the candidate image includes:
determining the first global difference degree between the target image and the extended subset corresponding to the candidate image by weighting a plurality of difference degrees between the target image and images in the extended subset corresponding to the candidate image, wherein for each of the images in the extended subset corresponding to the candidate image, a weighting coefficient corresponding to the image is negatively correlated with a difference degree between the image and the target image; and
the determining the second global difference degree between the candidate image and the extended subset corresponding to the target image includes:
determining the second global difference degree between the candidate image and the extended subset corresponding to the target image by weighting a plurality of difference degrees between the candidate image and images in the extended subset corresponding to the target image, wherein for each of the images in the extended subset corresponding to the target image, a weighting coefficient corresponding to the image is negatively correlated with a difference degree between the image and the candidate image.

28. The method of claim 20, wherein the method further includes:
identifying a first category of the target image and a second category of the result image;
determining a retrieval accuracy based on the first category and the second category; and
iteratively performing an image retrieval process until the retrieval accuracy satisfies a preset condition.

29-37. (canceled)

38. A non-transitory computer readable medium, comprising executable instructions that, when executed by at least one processor, direct the at least one processor to perform a method, the method comprising:
determining a plurality of difference degrees associated with an image set including a plurality of candidate images and a target image, each of the plurality of difference degrees corresponding to two images in the image set;
for each image in the image set, determining an extended subset based on the plurality of difference degrees;
for each of the plurality of candidate images, determining an extended difference degree between the candidate image and the target image based on an extended subset corresponding to the candidate image and an extended subset corresponding to the target image; and
identifying a result image corresponding to the target image from the plurality of candidate images based on the extended difference degrees corresponding to the plurality of candidate images.

39. The non-transitory computer readable medium of claim 38, wherein the determining the plurality of difference degrees associated with the image set including the plurality of candidate images and the target image includes:
for each image in the image set, determining a feature vector corresponding to the image by using a trained neural network model; and
determining a difference degree between any two images in the image set based on feature vectors corresponding to the two images.
